(19) United States
(12) Patent Application Publication
(10) Pub. No.: US 2025/0227824 A1
(43) Pub. Date: Jul. 10, 2025

(54) MULTI-MODE MICROWAVE ROLL-TO-ROLL NUT DRYING SYSTEM

(71) Applicants: Industrial Technology Research Institute, Hsinchu (TW); BEANS GROUP FOODS SCIENCE AND TECHNOLOGY CO., LTD., Taoyuan City (TW)

(72) Inventors: Kun-Ping Huang, Miaoli County (TW); Ting-Chia Chang, New Taipei City (TW)

(73) Assignees: Industrial Technology Research Institute, Hsinchu (TW); BEANS GROUP FOODS SCIENCE AND TECHNOLOGY CO., LTD., Taoyuan City (TW)

(21) Appl. No.: 19/000,560

(22) Filed: Dec. 23, 2024

Related U.S. Application Data
(60) Provisional application No. 63/614,619, filed on Dec. 24, 2023.

(30) Foreign Application Priority Data
Sep. 18, 2024 (TW) 113135315

(51) Int. Cl. H05B 6/80

(52) U.S. Cl. CPC H05B 6/80; H05B 2206/046

(57) ABSTRACT

A multi-mode microwave roll-to-roll nut drying system including an open drying chamber, a roll-to-roll device, a multi-mode microwave device and a hot air circulation device is provided. The open drying chamber includes an inlet, an outlet and a drying zone between the inlet and the outlet. The roll-to-roll device includes a conveyor belt, wherein the conveyor belt is configured to be conveyed through the inlet, the drying zone, and the outlet of the open drying chamber, and the conveyor belt is made of a non-microwave absorbing material. The multi-mode microwave device is installed above the open drying chamber to emit microwaves into the drying zone. The multi-modal microwave device includes microwave input ports, and any two adjacent ones of the microwave input ports are orthogonally arranged.

### CROSS-REFERENCE TO RELATED APPLICATION

This application claims the priority benefit of U.S. Provisional Application No. 63/614,619, filed on Dec. 24, 2023 and Taiwan Application No. 113135315, filed on Sep. 18, 2024. The entirety of each of the above-mentioned patent applications is hereby incorporated by reference herein and made a part of this specification.

### BACKGROUND

### Technical Field

The disclosure relates to a nut drying system, and particularly relates to a multi-mode microwave roll-to-roll nut drying system.

### Description of Related Art

A currently known nut drying method is to use a conventional electric hot air heating system to bake nuts, and such method belongs to indirect heating and belongs to conventional old type heating equipment, which results in thermal efficiency of less than 40%, and also leads to increased electricity consumption, time-consuming and high energy consumption. Each equipment running for 12 hours a day will consume up to 2000 kWh of electricity, and in terms of carbon emissions, this may result in 1.202 metric tons of carbon emissions per day. Calculated based on just one nut drying equipment, the annual carbon emissions may reach about 254.5 or even 300.5 metric tons, causing considerable environmental harm.

### SUMMARY

The disclosure provides a multi-mode microwave roll-to-roll nut drying system including an open drying chamber, a roll-to-roll device, a multi-mode microwave device and a hot air circulation device. The open drying chamber includes an inlet, an outlet and a drying zone between the inlet and the outlet. The roll-to-roll device includes a conveyor belt, wherein the conveyor belt is configured to be conveyed through the inlet, the drying zone, and the outlet of the open drying chamber, and the conveyor belt is made of a non-microwave absorbing material. The multi-mode microwave device is installed above the open drying chamber to emit microwaves into the drying zone. The multi-mode microwave device includes a plurality of microwave input ports, and any two adjacent ones of the microwave input ports are orthogonally arranged.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a three-dimensional schematic diagram of a multi-mode microwave roll-to-roll nut drying system according to an embodiment of the disclosure.

FIG. 1B is a schematic diagram of FIG. 1A with frames hidden.

FIG. 2 is a schematic side perspective view of the multi-mode microwave roll-to-roll nut drying system of FIG. 1A.

FIG. 3 is a schematic top view of a multi-mode microwave device of FIG. 1A and microwave attenuation structures.

FIG. 4 is a schematic partial cross-sectional view of FIG. 1A along a line A-A.

### DESCRIPTION OF THE EMBODIMENTS

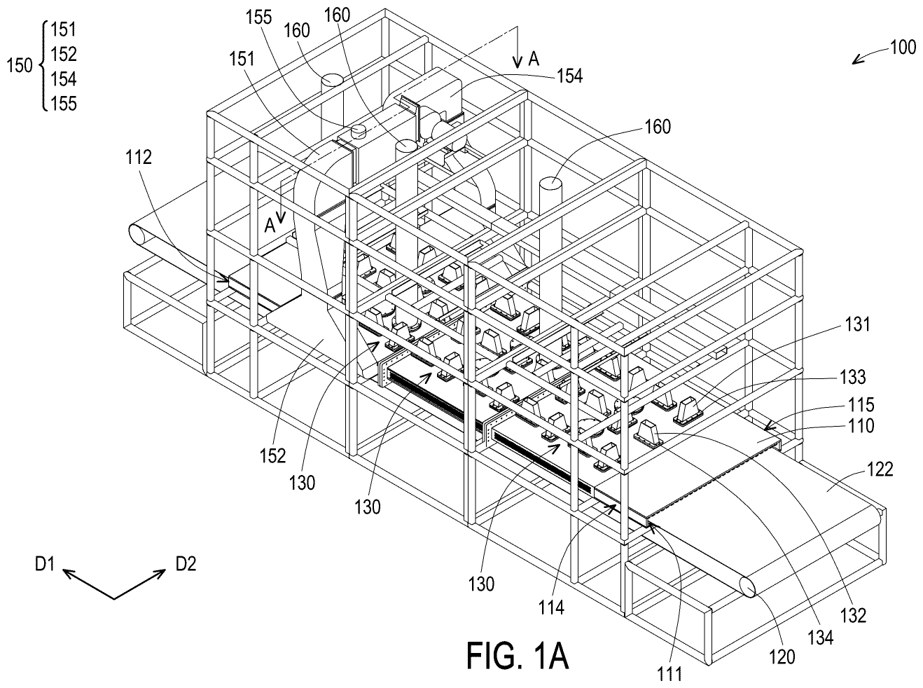

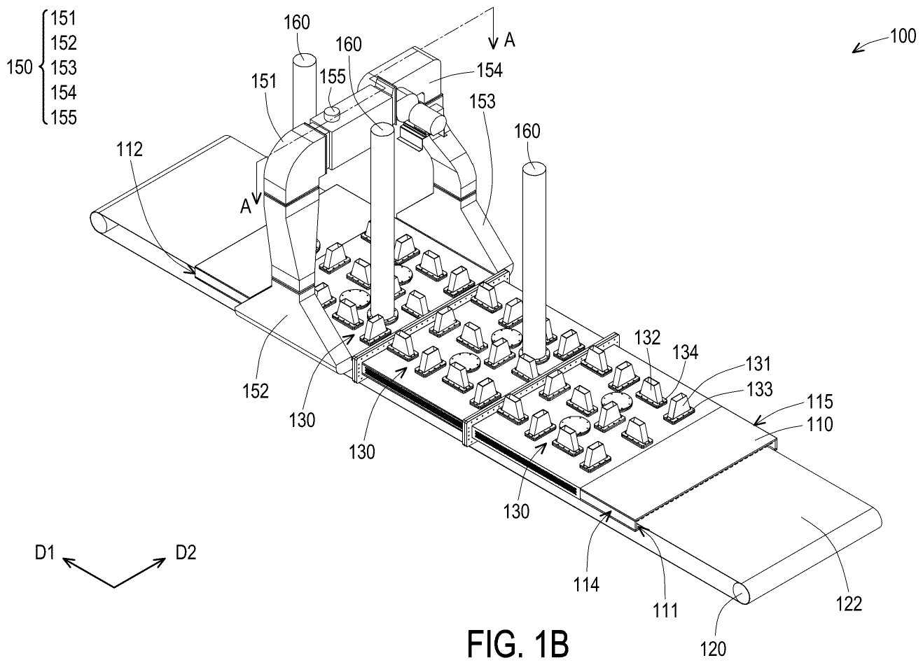

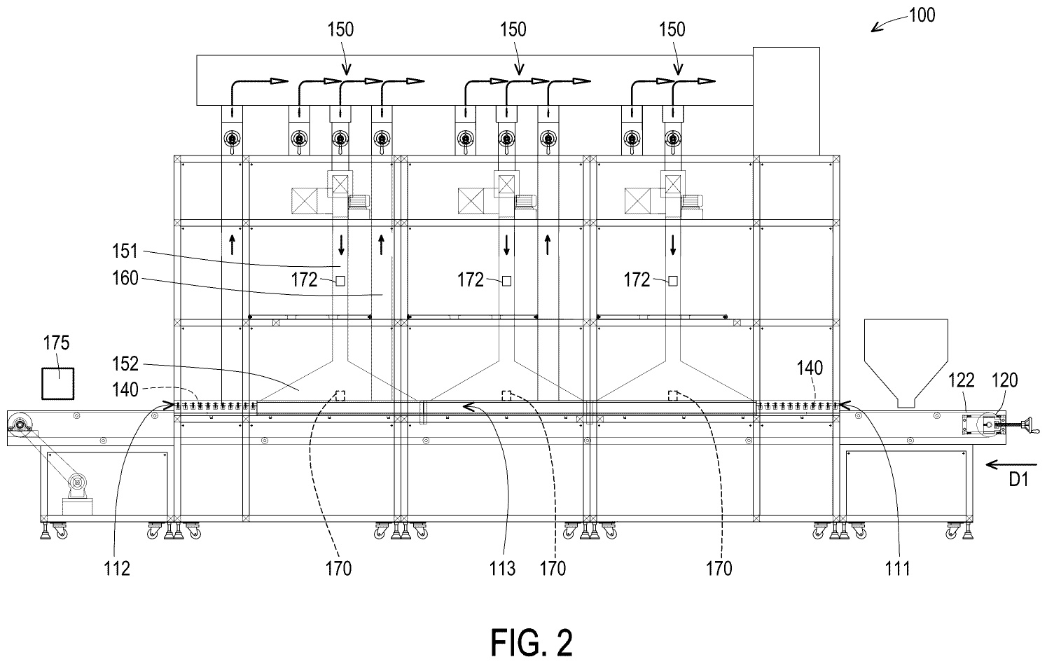

FIG. 1A is a three-dimensional schematic diagram of a multi-mode microwave roll-to-roll nut drying system according to an embodiment of the disclosure. FIG. 1B is a schematic diagram of FIG. 1A with frames hidden. FIG. 2 is a schematic side perspective view of the multi-mode microwave roll-to-roll nut drying system of FIG. 1A. It should be noted that FIG. 1A only shows one set of hot air circulation device, and hides the other two sets of hot air circulation devices to more clearly show the two sets of multi-mode microwave devices. In fact, the number of the hot air circulation devices may correspond to the number of the multi-mode microwave devices. In addition, the multi-mode microwave devices are hidden in FIG. 2 to keep the picture simple.

Referring to FIG. 1A to FIG. 2, a multi-mode microwave roll-to-roll nut drying system 100 of the embodiment includes an open drying chamber 110, a roll-to-roll device 120, a multi-mode microwave device 130 and a hot air circulation device 150.

The open drying chamber 110 includes an inlet 111, an outlet 112, and a drying zone 113 located between the inlet 111 and the outlet 112 (FIG. 2). The roll-to-roll device 120 includes a conveyor belt 122 that may be conveyed through the inlet 111, the drying zone 113 and the outlet 112 of the open drying chamber 110, and the conveyor belt 122 is made of a non-microwave absorbing material. The conveyor belt 122 is configured to convey nuts to pass through the open drying chamber 110.

Compared with the conventional method that nuts need to be heated in a closed chamber and then taken out, the open drying chamber 110 of the multi-mode microwave roll-to-roll nut drying system 100 of the disclosure is an open space, where nuts are continuously conveyed to pass through the open drying chamber 110 through the conveyor belt 122 of the roll-to-roll device 120 to achieve good processing efficiency, and achieve the effect of continuous processing, so as to increase production capacity.

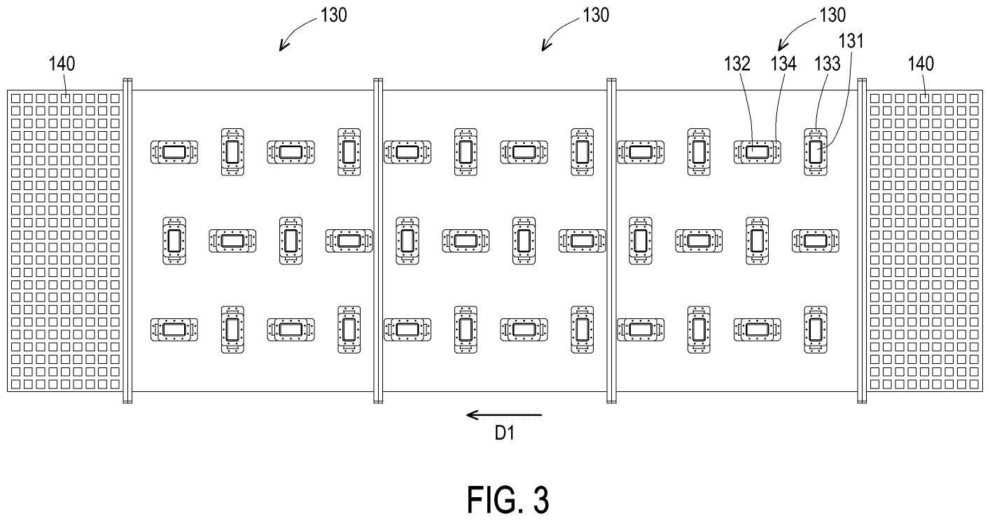

FIG. 3 is a schematic top view of a multi-mode microwave device of FIG. 1A and microwave attenuation structures. Referring to FIG. 1B and FIG. 3, in the embodiment, the multi-mode microwave device 130 is disposed above the open drying chamber 110 and passes through the open drying chamber 110 to emit microwaves into the drying zone 113 for direct heating and drying the nuts on the conveyor belt 122 passing through the drying zone 113, so as to achieve rapid heating and drying effects. Compared with the conventional baking method, the drying method of the disclosure is more energy-saving.

In the embodiment, a microwave frequency of the multi-mode microwave device 130 is between 300 MHz and 300 GHz, but the microwave frequency is not limited thereto. In addition, in the embodiment, three multi-mode microwave devices 130 are taken as an example for description, which are arranged along a direction D1 from the inlet 111 to the outlet 112, but the number of the multi-mode microwave devices 130 is not limited thereto.

In the embodiment, each of the multi-mode microwave devices 130 includes first microwave sources 131 and second microwave sources 132, and the first microwave sources 131 and the second microwave sources 132 are arranged orthogonally and in interleaving. The first microwave source 131 has a microwave input port 133, and the second microwave source 132 has a microwave input port 134. The microwave input ports 133 and 134 are arranged orthogonally, so that a direction of microwaves emitted by the first microwave sources 131 is orthogonal to a direction of microwaves emitted by the second microwave sources 132. Such design may effectively increase the intensity and uniformity of the microwaves in the drying zone 113. Each of the first microwave sources 131 and the second microwave sources 132 may be configured with a fan (not shown) to cool down.

As shown in FIG. 2 and FIG. 3, in the embodiment, the multi-mode microwave roll-to-roll nut drying system 100 further includes two microwave attenuation structures 140, which are respectively disposed in the open drying chamber 110 near the inlet 111 and the outlet 112, and configured to attenuate the microwaves to avoid a chance of microwave leakage from the inlet 111 and the outlet 112.

It should be noted that in FIG. 3, the multi-mode microwave devices 130 and the microwave attenuation structures 140 are not on a same plane. The multi-mode microwave devices 130 are located above the open drying chamber 110, and the microwave attenuating structures 140 are located in the open drying chamber 110. FIG. 3 is mainly used to describe that the microwave attenuation structures 140 are located on both sides of the multi-mode microwave devices 130 in the direction D1.

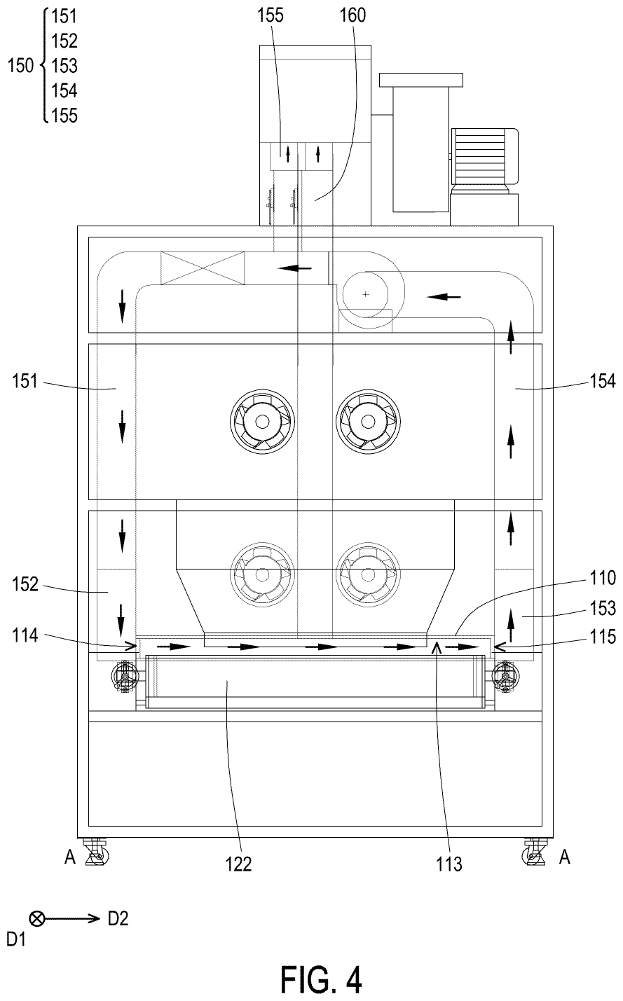

FIG. 4 is a schematic partial cross-sectional view of FIG. 1A along a line A-A. Referring to FIG. 1A and FIG. 4, the hot air circulation device 150 is disposed next to the open drying chamber 110 to enable dry hot air to pass through the drying zone 113. The hot air circulation device 150 includes a hot air inflow pipe 151, an expansion pipe 152, a contraction pipe 153, an outflow pipe 154 and an exhaust vent 155 (FIG. 4).

The hot air inflow pipe 151 is connected to the expansion pipe 152, and the expansion pipe 152 is communicated with the drying zone 113. As shown in FIG. 1B, a maximum width of the expansion pipe 152 in the direction D1 is greater than a width of the hot air inflow pipe 151 in the direction D1, so that the hot air may pass through the drying zone 113 in a wide range, and the drying zone 113 may be uniformly heated by the hot air. In addition, the contraction pipe 153 is connected between the drying zone 113 and the outflow pipe 154 to concentrate the hot air passing through the drying zone 113 to the outflow pipe 154. The outflow pipe 154 is connected to the exhaust vent 155 and the hot air inflow pipe 151.

Therefore, the hot air passing through the drying zone 113 may flow through the contraction pipe 153 and the outflow pipe 154, and a part of the hot air flowing through the outflow pipe 154 may flow to the hot air inflow pipe 151 and circulate again. The hot air in the hot air inflow pipe 151 may be heated by a heater (not shown) to ensure that the hot air entering the circulation is in a high temperature state. The other part of the hot air flowing through the outflow pipe 154 may flow to the exhaust vent 155 and leave the hot air circulation device 150.

As shown in FIG. 1B, in the embodiment, the maximum width of the expanded pipe 152 in the direction D1 may be close to a width of the corresponding multi-mode microwave device 130 in the direction D1, so that areas corresponding to the multi-mode microwave devices 130 in the drying zone 113 may be simultaneously heated by the hot air circulation device 150.

Certainly, in other embodiments, a relationship between the maximum width of the expansion pipe 152 and the width of the multi-mode microwave device 130 is not limited thereto, as long as the drying zone 113 may be heated simultaneously by the multi-mode microwave devices 130 and the hot air circulation device 150.

Referring to FIG. 1B and FIG. 4 together, the open drying chamber 110 includes a first side 114 and a second side 115 located between the inlet 111 and the outlet 112 and opposite to each other. The expansion pipe 152 passes through the first side 114 and the contraction pipe 153 passes through the second side 115.

In the embodiment, a connection line of the first side 114 and the second side 115 may extend along the direction D2, a connection line of the inlet 111 and the outlet 112 may extend along the direction D1, and the connection line of the first side 114 and the second side 115 is perpendicular to the connection line of the inlet 111 and the outlet 112, so that a flow direction (direction D2) of the dry hot air is perpendicular to a conveying direction (direction D1) of the conveyor belt 122. Such a design may enable hot air to pass over the conveyor belt 122 evenly.

The multi-mode microwave roll-to-roll nut drying system 100 uses the hot air circulation device 150 to deliver the dry hot air to pass through the drying zone 113 to further increase a temperature in the drying zone 113, thereby achieving an effect of improving a nut flavor. The dual heating method of microwave and hot air drying may also shorten a drying time of nuts and increase production capacity.

In addition, since nuts may produce moisture during the process of microwave and hot air drying, in the embodiment, the multi-mode microwave roll-to-roll nut drying system 100 further includes a moisture extraction device 160, which is communicated with the drying zone 113, and is used to extract moisture to accelerate the drying process.

As shown in FIG. 2, the multi-mode microwave roll-to-roll nut drying system 100 further includes thermometers 170, 172 and a control module 175. The thermometer 170 is, for example, an infrared thermometer, which is disposed above the drying zone 113 to detect the temperature in the drying zone 113. In an embodiment, the thermometers 170 may also be disposed on a plane of the multi-mode microwave devices 130 to monitor the nut temperature. In addition, the thermometer 172 is, for example, a thermocouple thermometer, which is disposed in the hot air inflow pipe 151 or the expansion pipe 152 to measure a temperature of the hot air. The control module 175 is electrically connected to the thermometers 170 and 172, the multi-mode microwave devices 130, the hot air circulation device 150 and the moisture extraction device 160. The control module 175 adjusts the multi-mode microwave devices 130, the hot air circulation device 150 and the moisture extraction device 160 through the temperatures returned by the thermometers 170 and 172 to maintain the drying zone 113 to the required temperature.

A following table compares the power consumption, yields and carbon emissions of the conventional old hot air baking system and the multi-mode microwave roll-to-roll nut drying system of the disclosure.

TABLE 1

| | | Usage | | Carbon | |
|---|---|---|---|---|---|
| | | amount | Yield | emissions | Carbon |
| | Usage | (1000 | (metric | (metric | emis- |
| | time | kWh/year) = | tons/ | tons of | sions/ |
| System | (day) | 250 days | year) | CO2e/year) | yield |
| Old hot air | 12 hours | 500 | 500 | 254.5 | 0.509 |
| baking | | | | | |
| system | | | | | |
| Multi-mode | 12 hours | 365.452 | 750 | 186.02 | 0.248 |
| microwave | | | | | |
| roll-to-roll | | | | | |
| nut drying | | | | | |
| system 100 | | | | | |

From the above, it may be seen that heating efficiency of the multi-mode microwave roll-to-roll nut drying system 100 is as high as 75%, and water molecules in the product may be directly and effectively heated for being quickly converted into vapor. Compared with the old hot air baking system that uses electric hot air for heating in batches, the multi-mode microwave roll-to-roll nut drying system 100 may reduce carbon emissions by up to 44% when processing each metric ton of product, which effectively reduces environmental impact, and also saves electricity consumption.

In summary, the multi-mode microwave roll-to-roll nut drying system of the disclosure may convey nuts to pass through the drying zone through the conveyor belt of the roll-to-roll device, which may achieve an effect of continuous processing and increase production capacity. Based on the above description, the multi-mode microwave roll-to-roll nut drying system of the disclosure conveys nuts to pass through the drying zone through the conveyor belt of the roll-to-roll device, which achieves an effect of continuous processing and increase production capacity. In addition, the multi-mode microwave roll-to-roll nut drying system of the disclosure emits microwaves into the drying zone through the multi-mode microwave device, and directly heats the nuts on the conveyor belt passing through the drying zone to achieve rapid heating and drying effects, so as to effectively save energy. Any two adjacent ones of the microwave input ports are arranged orthogonally, and such design effectively increases intensity and uniformity of the microwaves in the drying zone. Furthermore, the multi-mode microwave roll-to-roll nut drying system of the disclosure emits microwaves into the drying zone through the multi-mode microwave device, and directly heats the nuts on the conveyor belt that passes through the drying zone to achieve rapid heating and drying effects, which effectively saves energy. In addition, the multi-mode microwave roll-to-roll nut drying system of the disclosure further uses the hot air circulation device to deliver the dry hot air to pass through the drying zone to further increase the temperature in the drying zone, so as to achieve the effect of improving the nut's flavour. The dual heating method may also shorten the drying time of nuts and increase production capacity.

What is claimed is:

1. A multi-mode microwave roll-to-roll nut drying system, comprising:
an open drying chamber, comprising an inlet, an outlet and a drying zone between the inlet and the outlet;
a roll-to-roll device, comprising a conveyor belt, wherein the conveyor belt is configured to be conveyed through the inlet, the drying zone, and the outlet of the open drying chamber, and the conveyor belt is made of a non-microwave absorbing material; and
a multi-mode microwave device, installed above the open drying chamber to emit microwaves into the drying zone, the multi-mode microwave device comprising a plurality of microwave input ports, and any two adjacent ones of the microwave input ports are orthogonally arranged.

2. The multi-mode microwave roll-to-roll nut drying system as claimed in claim 1, wherein the multi-mode microwave device comprises a plurality of first microwave sources and a plurality of second microwave sources, a direction of microwaves emitted by the first microwave sources is orthogonal to a direction of microwaves emitted by the second microwave sources, and the first microwave sources and the second microwave sources are arranged in interleaving.

3. The multi-mode microwave roll-to-roll nut drying system as claimed in claim 1, further comprising a hot air circulation device installed next to the open drying chamber to enable dry hot air to pass through the drying zone.

4. The multi-mode microwave roll-to-roll nut drying system as claimed in claim 3, wherein the hot air circulation device comprises a hot air inflow pipe and an expansion pipe, the hot air inflow pipe is connected to the expansion pipe, a maximum width of the expansion pipe is greater than a width of the hot air inflow pipe, and the expansion pipe is communicated with the drying zone.

5. The multi-mode microwave roll-to-roll nut drying system as claimed in claim 4, wherein the hot air circulation device further comprises a contraction pipe, an outflow pipe and an exhaust vent, the contraction pipe is connected between the drying zone and the outflow pipe, and the outflow pipe is connected to the exhaust vent and the hot air inflow pipe.

6. The multi-mode microwave roll-to-roll nut drying system as claimed in claim 5, wherein the open drying chamber comprises a first side and a second side located between the inlet and the outlet and opposite to each other, the expansion pipe passes through the first side, and the contraction pipe passes through the second side, a connection line of the first side and the second side is perpendicular to a connection line of the inlet and the outlet, so that a flow direction of the dry hot air is perpendicular to a conveying direction of the conveyor belt.

7. The multi-mode microwave roll-to-roll nut drying system as claimed in claim 3, further comprising a thermometer and a control module, wherein the thermometer is arranged on an expansion pipe or a hot air inflow pipe of the hot air circulation device, and the control module is electrically connected to the thermometer and the hot air circulation device.

8. The multi-mode microwave roll-to-roll nut drying system as claimed in claim 1, further comprising a thermometer and a control module, wherein the thermometer is arranged above the drying zone, and the control module is electrically connected to the thermometer and the multi-mode microwave device.

9. The multi-mode microwave roll-to-roll nut drying system as claimed in claim 1, further comprising a moisture extraction device communicated with the drying zone.

10. The multi-mode microwave roll-to-roll nut drying system as claimed in claim 1, further comprising two microwave attenuation structures respectively arranged in the open drying chamber near the inlet and the outlet.
